(19) United States
(12) Patent Application Publication
(10) Pub. No.: US 2009/0211167 A1
(43) Pub. Date: Aug. 27, 2009

(54) SLURRY FOR WIRE SAW

(75) Inventors: Satoshi MATAGAWA, Tokyo (JP); Akira NAKASHIMA, Tokyo (JP); Takahisa NAKASHIMA, Tokyo (JP); Kazushige TAKAISHI, Tokyo (JP)

Correspondence Address: GREENBLUM & BERNSTEIN, P.L.C., 1950 ROLAND CLARKE PLACE, RESTON, VA, 20191, US

(73) Assignee: SUMCO CORPORATION, Tokyo (JP)

(21) Appl. No.: 12/388,823

(22) Filed: Feb. 19, 2009

(30) Foreign Application Priority Data
Feb. 21, 2008 (JP) 2008-40565

(51) Int. Cl. C09G 1/02

(52) U.S. Cl. 51/307

(57) ABSTRACT

A wire saw slurry containing, in a dispersing medium, 0.01-1 wt % of a metal film forming substance or a chelating agent that forms a film over copper in the dispersing medium. Entry of copper into a wafer bulk is prevented by the metal film forming substance or the chelating agent capturing the copper leaching out from brass plating of wires.

### CROSS-REFERENCE TO RELATED APPLICATIONS

The present application claims priority under 35 U.S.C. §119 of Japanese Application No. 2008-40565, filed on Feb. 21, 2008, the disclosure of which is expressly incorporated by reference herein in its entirety.

### BACKGROUND OF THE INVENTION

1. Field of the Invention

The present invention is related to slurry for a wire saw that slices a brittle material into semiconductor wafers through a use of loose abrasive grains, especially slurry for a wire saw that cuts a silicon single crystal ingot.

2. Description of Related Art

It is necessary to prevent pollution of copper (Cu) on silicon wafers. The copper pollution during the wafer manufacturing process can occur during a slicing process that slices a silicon single crystal ingot into a plurality of silicon wafers. This is due to the fact that wire-saw wires used during the slicing process are piano wires (steel wires) plated with brass (CuZn) on surfaces thereof, and that the brass plating may peel during the slicing process and the copper may drop on the wafer surfaces or enter into the bulk. Conventionally, the following composition has been used for the wire saw slurry during the slicing process. Namely, slurry is prepared by dispersing loose abrasive grains such as silicon carbide (SiC) at a predetermined concentration into a mineral oil system dispersing medium that is composed mostly of isoparaffin mineral oil, or into a glycol system dispersing medium that is composed mostly of diethylene glycol. Then, the loose abrasive grains in the slurry are held by the wires. Japanese Patent Laid-Open Publication No. 2006-111728 discloses the slurry for a wire saw.

However, with the conventional slurry for a wire saw, it is impossible to prevent the pollution of copper on the wafers, the copper being leached out from the brass plating of the wires during the slicing process.

### SUMMARY OF THE INVENTION

A feature of the present invention provides slurry for a wire saw that can decrease the copper pollution during the slicing process.

A first aspect of the invention provides wire saw slurry containing a dispersing medium and loose abrasive grains dispersed into the dispersing medium. The wire saw slurry has one of a film forming substance and a chelating agent that forms a metal film with respect to copper in the dispersing medium.

According to the first aspect of the invention, one of the film forming substance and the chelating agent is added to the wire saw slurry. Accordingly, the film forming substance or the chelating agent can capture copper or copper ions leached out in the wire saw slurry, which is caused by peeling of brass plating during a slicing process. Therefore, it is possible to prevent entry of the copper into a bulk of wafers and maintain a low concentration of the copper in sliced wafers. The film forming substance or the chelating agent contained in the dispersing medium of the wire saw slurry captures the copper or the copper ions leached out in the wire saw slurry. In other words, in case of the film forming substance, the copper ionization is suppressed by a filming effect through which the film forming substance films the surface of the copper leached out into the wire saw slurry. Accordingly, it is possible to prevent the copper from entering into the bulk of the sliced wafers. In case of the chelating agent, the chelating agent added to the slurry is bonded with the copper ions and a copper chelating compound, i.e., copper complex, is formed. Since this complex has electrical repulsion against wafers, the entry of the copper into the wafers is prevented. Accordingly, it is possible to prevent the copper from entering into the bulk of the sliced wafers.

It is possible to employ a silicon single crystal ingot, for example, as an object to be sliced by the wire saw. As a dispersing medium, a glycol system liquid that is composed mostly of diethylene glycol, or a mineral oil system liquid that is composed mostly of isoparaffin mineral oil may be used, for example. As loose abrasive grains (dispersing substance), fine powder of silicon carbide, diamond, or the like may be used, for example. The dispersing rate of the loose abrasive grains (dispersing substance) in the dispersing medium may be 30-70 wt %. When it is set lower than 30 wt %, the slicing accuracy is decreased because of increasing slicing resistance during the slicing process. Therefore, the slicing speed cannot be increased. When it is set higher than 70 wt %, breakage of wafers is cased during the slicing process because of increasing slurry viscosity. Therefore, the slicing speed cannot be increased, either. The more preferable dispersing rate of the loose abrasive grains in the dispersing medium is 40-60 wt %. In this range, it is possible to obtain more preferable effects that include improving slicing accuracy, decreasing wafer breakage, and increasing slicing speed.

The film forming substances may include phosphate, phosphonate, benzotriazole, and the like. Among them, phosphate is preferable due to high filming performance with respect to copper. Chelating agents may include EDTA (Ethylene Diamine Tetraacetic Acid), DTPA (Diethylene Triamine Pentaacetic Acid), TTHA (Triethylene Tetramine Hexaacetic acid), NTA (Nitrilo Triacetic Acid), HEDTA (Hydroxyethyl Ethylene Diamine Triacetic Acid), PDTA (1,3-Propanediamine Tetraacetic Acid), DPTA-OH (1,3-Diamino-2-hydroxypropane Tetraacetic Acid), HIDA (Hydroxyethyl Imino Diacetic Acid), DHEG (Dihydroxyethyl Glycine), GEDTA (Glycol Ether Diamine Tetraacetic Acid), CyDTA (trans-Cyclohexane Diamine Tetraacetic Acid), CMGA (Dicarboxymethyl Glutamic Acid), EDDS ((S,S)—Ethylene Diamine Disuccinic Acid), HEDP (Hydroxyethylidene Diphosphonic Acid), NTMP (Nitrilotris (Methylene Phosphonic Acid)), PBTC (Phosphonobutane Tricarboxylic Acid), EDTMP (Ethylene Diamine Tetra (Methylene Phosphonic Acid)), and their alkaline and ammonium salts. Among the listed chelating agents, EDTA is preferable because of its high water-solubility and pH-neutral characteristics that have less interference with the other slurry components.

A second aspect of the invention provides the wire saw slurry, wherein one of the film forming substance and the chelating agent is added to the dispersing medium at a rate ranging from 0.01 wt % -1 wt %. When the additive rate of the film forming substance or the chelating agent in the dispersing medium is lower than 0.01 wt %, the copper pollution prevention effect on the wafers is not achieved. In addition, when the additive rate of the film forming substance or the chelating agent in the dispersing medium exceeds 1 wt %, it has proven not to be economical, since the cooper pollution prevention effect remains the same as when the additive rate of 1 wt % is used. A preferable additive rate of the film forming substance or the chelating agent in the dispersing medium is 0.1-0.5 wt %. With this range, it is possible to obtain an effective cooper pollution prevention result on the wafers with the appropriate additive rate of the film forming substance or the chelating agent in the dispersing medium.

A third aspect of the invention provides the wire saw slurry, wherein the film forming substance includes phosphate. The phosphate may include sodium dihydrogen phosphate and potassium dihydrogen phosphate.

A fourth aspect of the invention provides the wire saw slurry, wherein the phosphate includes potassium dihydrogen phosphate.

A fifth aspect of the invention provides the wire saw slurry, wherein the chelating agent includes EDTA (ethylene diamine tetraacetic acid).

A sixth aspect of the invention provides the wire saw slurry, wherein the chelating agent includes diethylene triamine pentaacetic acid.

A seventh aspect of the invention provides the wire saw slurry, wherein the dispersing medium comprises a glycol system dispersing medium.

A eighth aspect of the invention provides the wire saw slurry, wherein the dispersing medium comprises a glycol system dispersing medium.

A ninth aspect of the invention provides the wire saw slurry, wherein the dispersing medium comprises a glycol system dispersing medium.

A tenth aspect of the invention provides the wire saw slurry, wherein the dispersing medium comprises a glycol system dispersing medium.

A eleventh aspect of the invention provides the wire saw slurry, wherein the dispersing medium comprises a mineral oil system dispersing medium. According to the aspect of the invention, it is possible to prevent the copper pollution of the sliced wafers during the slicing process by the wire saw. For example, the concentration of the copper entering into the wafers, which is sliced from the silicon single crystal, can be controlled to 5×10¹¹ atoms/cm³ or lower.

A twelfth aspect of the invention provides the wire saw slurry, wherein the dispersing medium comprises a mineral oil system dispersing medium.

A thirteenth aspect of the invention provides the wire saw slurry, wherein the dispersing medium comprises a mineral oil system dispersing medium.

A fourteenth aspect of the invention provides the wire saw slurry, wherein the dispersing medium comprises a mineral oil system dispersing medium.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention.

The following provides a detail description of an embodiment of the wire saw slurry according to the present invention.

The following illustrates experimental examples.
Wire saw apparatus used: MWM454B manufactured by Nippei Toyama Corporation
Wire used: Saw wire manufactured by Japan Fine Steel Co., Ltd.
Wire saw slurry used: Dispersing medium (Glycol system), Dispersing substance (SiC)
Sliced object: Silicon single crystal ingot

During the slicing process, a columnar silicon single crystal ingot having a maximum diameter of 300 mm is pressed against wires and sliced into a plurality of silicon wafers, the wires being wound in an even pitch on a plurality of main rollers built in a wire saw and run at a high speed (diameter 140 μm; surface being plated with brass plating (CuZn)) while being coated by slurry. The slurry used contains a glycol system dispersing medium, main component of the medium being diethylane glycol, and a dispersing substance of SiC having a mesh size of #1500. The additive rate of the dispersing substance within the dispersing medium is 47%. The slurry dispersing medium is mixed with, as film forming substance, potassium dihydrogen phosphate or benzotriazole ranging from 0.005-2 wt % of the dispersing medium weight. Then, the silicon single crystal ingot is sliced to obtain silicon wafers. In addition, the slurry dispersing medium is mixed with, as chelating agent, EDTA or DTPA ranging from 0.005-2 wt % of the dispersing medium weight. Then, the silicon single crystal ingot is sliced to obtain silicon wafers.

The measuring method of copper contained in the silicon wafers obtained after slicing the silicon single crystal ingot is as follows. First, a reactor container configured with an acid-proof container and a lid, having a supporting table therein is prepared. The supporting table is configured with a stand and a table, and the most of the peripheral portion of the table is projectively provided with a flange. Also, a decomposition liquid is prepared by evenly combining HF (hydrogen fluoride), HNO₃ (nitric acid) and H₂SO₄ (sulfuric acid).

Then, the decomposition liquid is stored in the container. A silicon wafer is horizontally placed on the top surface of the table, the lid is closed to seal the container, and the container was left for approximately 12 hours at room temperature. Accordingly, the silicon wafer is decomposed and sublimated, leaving a residue on the table of the supporting table. Next, the lid of the container is opened to dissolve the residue by dropping 1 ml of hydrochloric and hydrofluoric acid mixture liquid, per 1 gram of the residue, and to collect the residue in a beaker. The beaker is then heated to 80° C., and the residue is decomposed and sublimated. Then, minute impurities are collected in a dilute aqueous solution, a mixture of HF (hydrogen fluoride) and HNO₃ (nitric acid), and the collected liquid is measured by an AAS analysis device (frame atom absorption spectral device), for a quantitative analysis of copper. Charts 1 and 3 each illustrate the measurement result of the copper contained in the silicon wafer, obtained by mixing, as film forming substance, potassium dihydrogen phosphate or benzotriazole into the dispersing medium and slicing the silicon single crystal ingot. Charts 2 and 4 each illustrate the measurement result of the copper contained in the silicon wafer obtained by mixing, as a chelating agent, EDTA or DTPA into the dispersing medium and slicing the silicon single crystal ingot. In the experimental examples, each of the additive rates of potassium dihydrogen phosphate, EDTA, benzotriazole, and DTPA is set at 0.01-1.0 wt %.

CHART 1

| | Additive rate of | Concentration of |
|---|---|---|
| | potassium dihydrogen | Cu detected |
| | phosphate in dispersing | from wafer |
| | medium (wt %) | (×10¹¹ atoms/cm³) |
| Comparative Example 1 | 0 | 12.00 |
| Comparative Example 2 | 0.005 | 11.00 |
| Experimental Example 1 | 0.01 | 4.65 |
| Experimental Example 2 | 0.05 | 3.80 |
| Experimental Example 3 | 0.1 | 2.70 |
| Experimental Example 4 | 0.5 | 2.40 |
| Experimental Example 5 | 1.0 | 2.30 |
| Comparative Example 3 | 1.5 | 2.25 |
| Comparative Example 4 | 2.0 | 2.22 |

CHART 2

| | Additive rate | Concentration |
|---|---|---|
| | of EDTA | of Cu detected |
| | in dispersing | from wafer |
| | medium (wt %) | (×10¹¹ atoms/cm³) |
| Comparative Example 1 | 0 | 12.00 |
| Comparative Example 5 | 0.005 | 10.00 |
| Experimental Example 6 | 0.01 | 4.55 |
| Experimental Example 7 | 0.05 | 3.65 |
| Experimental Example 8 | 0.1 | 2.45 |
| Experimental Example 9 | 0.5 | 2.20 |
| Experimental Example 10 | 1.0 | 2.10 |
| Comparative Example 6 | 1.5 | 2.03 |
| Comparative Example 7 | 2.0 | 2.00 |

CHART 3

| | Additive rate | Concentration |
|---|---|---|
| | of benzotriazole | of Cu detected |
| | in dispersing | from wafer |
| | medium (wt %) | (×10¹¹ atoms/cm³) |
| Comparative Example 1 | 0 | 12.00 |
| Comparative Example 8 | 0.005 | 11.80 |
| Experimental Example 11 | 0.01 | 5.00 |
| Experimental Example 12 | 0.05 | 4.20 |
| Experimental Example 13 | 0.1 | 3.10 |
| Experimental Example 14 | 0.5 | 2.64 |
| Experimental Example 15 | 1.0 | 2.56 |
| Comparative Example 9 | 1.5 | 2.54 |
| Comparative Example 10 | 2.0 | 2.47 |

CHART 4

| | Additive rate | Concentration |
|---|---|---|
| | of DTPA in | of Cu detected |
| | dispersing | from wafer |
| | medium (wt %) | (×10¹¹ atoms/cm³) |
| Comparative Example 1 | 0 | 12.00 |
| Comparative Example 11 | 0.005 | 11.45 |
| Experimental Example 16 | 0.01 | 4.80 |
| Experimental Example 17 | 0.05 | 4.00 |
| Experimental Example 18 | 0.1 | 2.80 |
| Experimental Example 19 | 0.5 | 2.55 |
| Experimental Example 20 | 1.0 | 2.40 |
| Comparative Example 12 | 1.5 | 2.35 |
| Comparative Example 13 | 2.0 | 2.30 |

As it is apparent from Charts 1-4, it is possible, in experimental examples 1-20, to reduce the copper concentration on the silicon wafers (copper pollution amount) to 5.0×10¹¹ atoms/cm³ or lower. On the other hand, in comparative examples 1, 2, 5, 8, and 11, the copper concentration on the silicon wafers was 1.0×10¹² atoms/cm³ or higher. In addition, in comparative examples 3, 4, 6, 7, 9, 10, 12, and 13, the additive rate of the film forming substance or the chelating agent in the dispersing medium exceeds 1.0 wt %. However, compared to the additive rate of the film forming substance or the chelating agent in the dispersing medium of 1.0 wt %, there was no significant decrease of the copper concentration detected from the silicon wafers. Accordingly, it was discovered that, by adding 0.01-1 wt % of the film forming substance or the chelating agent in the dispersing medium of the wire saw slurry, it is possible to decrease the copper pollution of the wafers caused during the slicing process.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A wire saw slurry containing a dispersing medium and loose abrasive grains dispersed into the dispersing medium, the slurry comprising:
one of a film forming substance and a chelating agent that forms a metal film with respect to copper in the dispersing medium.

2. The wire saw slurry according to claim 1, wherein one of the film forming substance and the chelating agent is added to the dispersing medium at a rate ranging from 0.01 wt %-1 wt %.

3. The wire saw slurry according to claim 1, wherein the film forming substance includes phosphate.

4. The wire saw slurry according to claim 3, wherein the phosphate includes potassium dihydrogen phosphate.

5. The wire saw slurry according to claim 1, wherein the chelating agent includes EDTA (ethylene diamine tetraacetic acid).

6. The wire saw slurry according to claim 1, wherein the chelating agent includes diethylene triamine pentaacetic acid.

7. The wire saw slurry according to claim 1 wherein the dispersing medium comprises a glycol system dispersing medium.

8. The wire saw slurry according to claim 3, wherein the dispersing medium comprises a glycol system dispersing medium.

9. The wire saw slurry according to claim 5, wherein the dispersing medium comprises a glycol system dispersing medium.

10. The wire saw slurry according to claim 6, wherein the dispersing medium comprises a glycol system dispersing medium.

11. The wire saw slurry according to claim 1, wherein the dispersing medium comprises a mineral oil system dispersing medium.

12. The wire saw slurry according to claim 3, wherein the dispersing medium comprises a mineral oil system dispersing medium.

13. The wire saw slurry according to claim 5, wherein the dispersing medium comprises a mineral oil system dispersing medium.

14. The wire saw slurry according to claim 6, wherein the dispersing medium comprises a mineral oil system dispersing medium.

15. The wire saw slurry according to claim 2, wherein the film forming substance includes phosphate.

16. The wire saw slurry according to claim 2, wherein the chelating agent includes EDTA (ethylene diamine tetraacetic acid).

17. The wire saw slurry according to claim 2, wherein the chelating agent includes diethylene triamine pentaacetic acid.

18. The wire saw slurry according to claim 2, wherein the dispersing medium comprises a glycol system dispersing medium.

19. The wire saw slurry according to claim 4, wherein the dispersing medium comprises a glycol system dispersing medium.

20. The wire saw slurry according to claim 2, wherein the dispersing medium comprises a mineral oil system dispersing medium.

21. The wire saw slurry according to claim 4, wherein the dispersing medium comprises a mineral oil system dispersing medium.
